(19) United States
(12) Patent Application Publication
(10) Pub. No.: US 2026/0300499 A1
(43) Pub. Date: Oct. 1, 2026

(54) METHODS AND SYSTEMS FOR GENERATING CUSTOMIZABLE TEST CASES FROM RESOURCES WITH EMBEDDED VULNERABILITY INDICATORS

(71) Applicant: GitLab Inc., San Francisco, CA (US)

(72) Inventors: Hua Yan, Sydney (AU); Jason Leasure, Columbia, MD (US); Julian Thome, Esch-sur-Alzette (LU); Adam Cohen, Bondi Beach (AU); Craig Mark Smith, Gold Coast (AU); Tal Kopeliovich, Beer Sheva (IL)

(21) Appl. No.: 19/096,136

(22) Filed: Mar. 31, 2025

(51) Int. Cl. G06F 21/57; G06F 21/55

(52) U.S. Cl. CPC G06F 21/577; G06F 21/552

(57) ABSTRACT

A computing system accesses a resource from a repository. The resource includes a source code having functions with embedded vulnerability indicators. The system parses the source code to generate a tree structure. The system identifies one or more functions from the tree structure based on syntactic analysis. The system determines, for each identified function, a vulnerability signal based on analysis of the embedded vulnerability indicators. The system applies a rule set using the vulnerability signal to select each identified function for inclusion in an aggregate function file. The system generates the aggregate function file by selectively appending thereto functions selected based on the rule set.

### BACKGROUND

### Technical Field

The subject matter described relates to automated generation of benchmark test cases for security analysis tools through fault-tolerant syntactic parsing of resources with embedded vulnerability indicators.

### Background Information

Static application security testing (SAST) tools are used to identify potential security vulnerabilities in software during the development process, enabling developers to address issues before deployment. Evaluating the effectiveness and performance of these tools requires appropriate benchmark test cases that reflect real-world coding scenarios with varying levels of complexity and vulnerability patterns. Conventional approaches to generating test cases for SAST tools often rely on manually crafted examples or simplistic test suites that fail to adequately represent the diversity and complexity of production code. The existing benchmark suites typically contain small programs that are easily scanned by SAST tools, thereby providing limited insight into a tool's capability to detect vulnerabilities in larger, more complex codebases.

Additionally, current benchmarking approaches generally lack customization options for controlling characteristics such as vulnerability density, code complexity, and sample size, making it difficult to systematically evaluate SAST tools under specific conditions. Furthermore, many existing test case generation methods require complete, compilable code, limiting their ability to extract valuable test patterns from partial or syntactically incomplete source code samples that might otherwise serve as useful benchmarks.

### SUMMARY

The above and other problems may be addressed by methods and systems for generating syntax-correct test cases with customizable vulnerability densities through fault-tolerant parsing of source code functions, providing more effective and realistic evaluation of SAST tools. In one embodiment, a computing system accesses a resource from a repository. The resource includes source code having functions with embedded vulnerability indicators. The system parses the source code to generate a tree structure. The system identifies one or more functions from the tree structure based on syntactic analysis. The system determines, for each identified function, a vulnerability signal based on analysis of the embedded vulnerability indicators. The system applies a rule set using the vulnerability signal to select each identified function for inclusion in an aggregate function file. The system generates the aggregate function file by selectively appending thereto functions selected based on the rule set.

### BRIEF DESCRIPTION OF THE DRAWINGS

FIG. 1 is a block diagram of a networked computing environment, according to one embodiment.

FIG. 2 illustrates a block diagram of the computing server of FIG. 1, according to one embodiment.

FIG. 3 is a flowchart depicting a process generating benchmark test cases, according to one embodiment.

FIG. 4 is a block diagram illustrating an example computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements unless the context indicates otherwise.

A syntax-directed SAST benchmark generation system can address fundamental limitations in existing SAST evaluation methodologies. The system can automate the generation of customizable test cases from source code samples. A test case in this context refers to a specially crafted code sample containing known security vulnerabilities that serves as a reference standard for evaluating the detection capabilities of SAST tools. In one embodiment. the system can generate syntactically correct test cases of a range of complexities, quantities, and bug densities to evaluate the performance and detection effectiveness of SAST tools directly within integrated development environments (IDEs). The system may use fault-tolerant syntax analysis, which allows the extraction of function seeds from source code samples without requiring full compilation and expands the corpus of existing available code that may be used to generate test cases.

In some embodiments, the system uses a parsing engine that can process incomplete or partially incorrect source code, extract function definitions with embedded vulnerability indicators, and transform these into structured representations for further manipulation and analysis. The system may also employ a multi-stage process that includes accessing source repositories, parsing code into tree structures, identifying functions through syntactic analysis, determining vulnerability signals, applying selection rules based on configurable parameters, and generating aggregate function files that meet specific security testing requirements. Using some or all of these techniques, the system may generate large-scale test cases for SAST within an IDE environment, providing developers with immediate feedback on security vulnerabilities during the coding process rather than as a separate post-development analysis.

The system's ability to produce hybrid test programs that combine code structures with known vulnerabilities creates more challenging and realistic evaluation scenarios than existing benchmark suites, which often contain simplified or artificial test cases that fail to represent the complexity of production software.

In some embodiments, a workflow of the system follows two parallel paths that converge to produce robust testing capabilities. In the first path, predefined SAST-rules tests, which are specifically designed based on security rules to evaluate the recall capabilities of SAST tools, directly contribute to the creation of hybrid tests. In the second path, top open-source software (OSS) repositories containing source code are processed to extract syntactically correct functions, regardless of whether the original code is complete or compilable. These extracted functions become function seeds—customizable function snippets that serve as building blocks for test generation—which are then filtered and processed based on user-defined parameters such as complexity and vulnerability density. Both paths lead to the generation of hybrid tests, which strategically combine source code structures and vulnerability patterns to form test cases (or programs) specifically optimized for comprehensive SAST tool evaluation. This dual-input approach provides that the resulting test cases reflect both the theoretical security concerns captured in SAST rules and the practical coding patterns found in production software, creating a more holistic evaluation framework for security testing tools.

### Example Systems

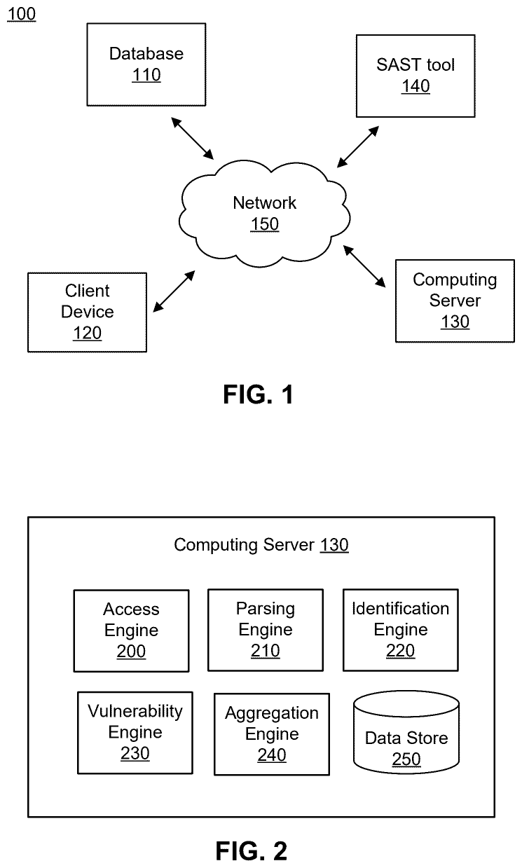

FIG. 1 illustrates one embodiment of a networked computing environment 100 suitable for generating test cases. In the embodiment shown, the networked computing environment 100 includes a database 110, one or more client devices 120, a computing server 130, and one or more SAST tools 140, all connected via a network 150. In other embodiments, the networked computing environment 100 includes different or additional elements. In addition, the functions may be distributed among the elements in a different manner than described. For example, although the client device 120 and the computing server 130 are shown as distinct entities, in some embodiments their corresponding functionality is provided by a single computing system (e.g., a server).

The database 110 includes one or more computer-readable storage media that store resources including codes for one or more software projects. In some embodiments, the database 110 stores source code files, extracted function seeds, and generated test cases. The database 110 maintains a collection of programming examples with embedded vulnerability indicators that serve as the foundation for benchmark generation. The vulnerability indicators may be tagged by human developers to existing code to indicate vulnerabilities, vulnerabilities generated by trusted SAST tools (possibly subject to human verification), or a mixture of both.

The client devices 120 are used by software engineers to configure and interact with the benchmark generation system. Engineers use these devices to specify parameters such as target vulnerability density, tree depth, and file size for generating customized test cases.

The computing server 130 is a processing component that implements the benchmark generation framework. It performs fault-tolerant syntax parsing of source code, identifies functions with embedded vulnerability indicators, calculates vulnerability densities, and selectively aggregates functions into syntactically correct test cases based on specified parameters.

The SAST tools 140 are devices that implement security analysis applications for examining the generated test cases to identify potential vulnerabilities. These tools serve as the evaluation targets for the benchmark generation system, with their performance being measured against the customized test cases with known vulnerabilities.

The network 150 provides the communication channels via which the other elements of the networked computing environment 100 communicate. The network 150 can include any combination of local area and wide area networks, using wired or wireless communication systems. In one embodiment, the network 150 uses standard communications technologies and protocols. For example, the network 150 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 150 may be encrypted using any suitable technique or techniques.

FIG. 2 illustrates one embodiment of the computing server 130 of FIG. 1. In the embodiment shown, the computing server 130 includes an access engine 200, a parsing engine 210, an identification engine 220, a vulnerability engine 230, an aggregation engine 240, and a data store 250. In other embodiments, the computing server 130 includes different or additional elements. In addition, the functions may be distributed among the elements in a different manner than described.

The access engine 200 accesses a resource from a repository. The resource includes source code having functions with embedded vulnerability indicators. For example, the access engine 200 provides an interface between the computing server 130 and various code repositories, enabling the retrieval of appropriate source files for test case generation.

In some embodiments, the access engine 200 accesses the resource from the repository by identifying a programming language for the test cases and selecting the resource from the repository based on file extensions corresponding to the identified programming language. This language-specific selection process provides that only relevant files are processed, improving efficiency and maintaining language consistency in the generated test cases. The embedded vulnerability indicators include data elements (e.g., comments) within the functions, the data elements indicating potential security vulnerabilities. The indicators may be purposefully placed within the source code to mark locations where security weaknesses exist, providing reference points for vulnerability density calculations and enabling the system to generate test cases with predictable security characteristics.

In some embodiments, the access engine 200 receives input parameters including: a target size for the aggregate function file, a target tree depth, and a target vulnerability density. These parameters enable precise customization of the generated test cases, allowing users to specify the desired file size for performance testing, the complexity level through tree depth settings, and the concentration of security vulnerabilities to evaluate SAST tool effectiveness under various conditions. The access engine 200 can also receive a predetermined vulnerability threshold as an input parameter. This threshold value serves as a configurable criterion for selecting functions with specific vulnerability characteristics, allowing users to adjust the sensitivity of the vulnerability detection process according to their testing requirements.

The parsing engine 210 parses the source code to generate a tree structure that represents the hierarchical organization of code elements, transforming linear text into a navigable format for analysis. In one embodiment, the parsing engine 210 is a parser generator, which is specialized software that creates parsers based on formal grammar definitions. Parser generators (e.g., tree-sitter, etc.) may create parsing code that can transform source text into structured representations.

In some embodiments, the parsing engine 210 parses incomplete or partially incorrect source code and generates the tree structure without requiring full compilation of the source code. This fault-tolerant approach provides processing of code samples that may contain errors or dependencies that would prevent traditional compilation. These features greatly expand the pool of available source code for test case generation. The parsing engine 210 may identify code components in the tree structure such as function definitions, variable definitions, and preprocessor directives. This detailed categorization of code elements can enable the system to isolate specific components of interest, particularly function definitions that will serve as building blocks for the generated test cases, while maintaining awareness of their relationships with other code elements.

The identification engine 220 identifies one or more functions from the tree structure based on syntactic analysis. The identification engine 220 traverses the parsed tree structure to locate and extract distinct function elements that will serve as candidates for inclusion in the test cases. In one embodiment, the identification engine 220 identifies functions from the tree structure by analyzing components of the tree structure to determine whether a component is a function definition, a variable definition, or a preprocessor directive. The identification engine 220 further selects the components identified as function definitions. This classification process allows precise isolation of executable code units while filtering out non-function elements, providing that only appropriate code blocks are considered for the aggregate function file.

The identification engine 220 determines a depth of each function in the tree structure and selects functions having depths within a predetermined range. This depth analysis serves as a proxy for code complexity, allowing the system to filter functions based on their structural complexity, selecting simpler functions with shallow tree depths or more complex functions with deeper nesting levels based on the desired characteristics of the test cases. These features provide the generation of test cases with consistent complexity metrics for performance evaluations of SAST tools.

The vulnerability engine 230 determines, for each identified function, a vulnerability signal based on analysis of the embedded vulnerability indicators. These features process each function to quantify its security risk profile, providing a measurable metric for vulnerability assessment. In one embodiment, the vulnerability engine 230 determines the vulnerability signal by parsing data elements associated with each identified function, identifying the embedded vulnerability indicators within the parsed data elements, calculating a count of the identified embedded vulnerability indicators within each function, determining a number of lines of code for each function, computing a vulnerability density as a ratio of the count of identified embedded vulnerability indicators to the number of lines of code, and determining the vulnerability signal as a function of the computed vulnerability density. This systematic approach may transform qualitative vulnerability information into quantitative metrics, providing objective comparison and selection of functions based on their security characteristics.

The vulnerability engine 230 may categorize the vulnerability indicators into different vulnerability types and assign numerical weights to each vulnerability type based on a severity metric. In one embodiment. the vulnerability engine 230 calculate a weighted count by applying the numerical weights to the count of vulnerability indicators of each vulnerability type, compute a weighted vulnerability density as a ratio of the weighted count to the number of lines of code, and determine the vulnerability signal as a function of the weighted vulnerability density. This analysis accounts for the varying impact of different vulnerability types, allowing the system to prioritize more severe security issues when calculating vulnerability density. By incorporating severity weighting, the vulnerability engine provides more nuanced and realistic security assessments that better reflect the actual risk profile of functions, leading to more effective test cases for evaluating SAST tool capabilities.

The aggregation engine 240 applies, for each function, a rule set using the vulnerability signal to select each identified function for inclusion in an aggregate function file. These features implement the decision-making logic that determines which functions will be incorporated into the final test cases based on their vulnerability characteristics. In one embodiment, the aggregation engine 240 applies the rule set by comparing the vulnerability signal of each identified function against a predetermined vulnerability threshold. This threshold-based selection mechanism provides that only functions with vulnerability signals exceeding the specified level are included in the aggregate function file, allowing precise control over the security profile of the test cases.

In some embodiments, the access engine 200 receives the predetermined vulnerability threshold as an input parameter. This configurable threshold serves as a control point for the system, allowing users to specify the minimum vulnerability level required for functions to be considered for inclusion in test cases. By providing this parameter externally, the system offers flexibility to adjust selection criteria based on specific testing objectives or security evaluation requirements. The vulnerability engine 230 can adjust the predetermined vulnerability threshold based on a target vulnerability density for the aggregate function file. This dynamic approach allows the system to dynamically modify selection criteria during the test case generation process, providing the final output meets the specified vulnerability density targets. If the initial function selections would result in a density that deviates from the target, the vulnerability engine can incrementally adjust the threshold up or down, recalibrating the selection process to achieve the desired vulnerability concentration in the aggregate function file.

The aggregation engine 240 generates the aggregate function file by selectively appending thereto functions selected based on the rule set. These features provide the final assembly of the test case file, strategically combining qualifying functions to create an output that meets all specified requirements. In one embodiment, the aggregation engine 240 retrieves function definitions from the tree structure for the functions having vulnerability signals exceeding a predetermined vulnerability threshold, and combines the retrieved function definitions into the aggregate function file. This retrieval and combination process provides that only functions with sufficient vulnerability characteristics are incorporated, maintaining the security profile integrity of the generated test cases.

In some embodiments, the access engine 200 receives input parameters including a target size for the aggregate function file, a target tree depth, and a target vulnerability density. The aggregation engine 240 can generate the aggregate function file by selecting functions whose tree structures have depths matching the target tree depth, and continuing to append the selected functions to the aggregate function file until the aggregate function file reaches the target size. The aggregation engine 240 can validate the aggregate function file to include a vulnerability density matching the target vulnerability density. This multi-criteria approach provides the generated test cases simultaneously satisfy size, complexity, and security requirements, producing customized benchmarks for precise SAST tool evaluation.

The aggregation engine can validate the aggregate function file using the parser generator to verify syntactic correctness. This validation step provides that the combined functions maintain proper syntax despite being extracted from different contexts, confirming that the generated test cases are structurally sound and suitable for analysis by SAST tools.

In some embodiments, the aggregation engine 240 can use the aggregate function file to evaluate a performance of a security testing tool. This direct application capability allows the system to not only generate test cases but also facilitate their immediate use in performance benchmarking, providing an end-to-end solution for SAST tool evaluation.

The data store 250 provides storage features for the computing server 130, maintaining the resources and outputs created during the benchmark generation process. It stores source code files accessed from repositories, parsed tree structures created by the parsing engine, identified functions extracted by the identification engine, and vulnerability metrics calculated by the vulnerability engine. The data store 250 also maintains the aggregate function files generated by the aggregation engine, serving as both an intermediate workspace and a repository for final test cases. Additionally, it stores configuration parameters and threshold values used by the various engines. The data store 250 implements appropriate indexing and retrieval mechanisms to efficiently manage the relationships between source files, extracted functions, and generated test cases.

### Example Methods

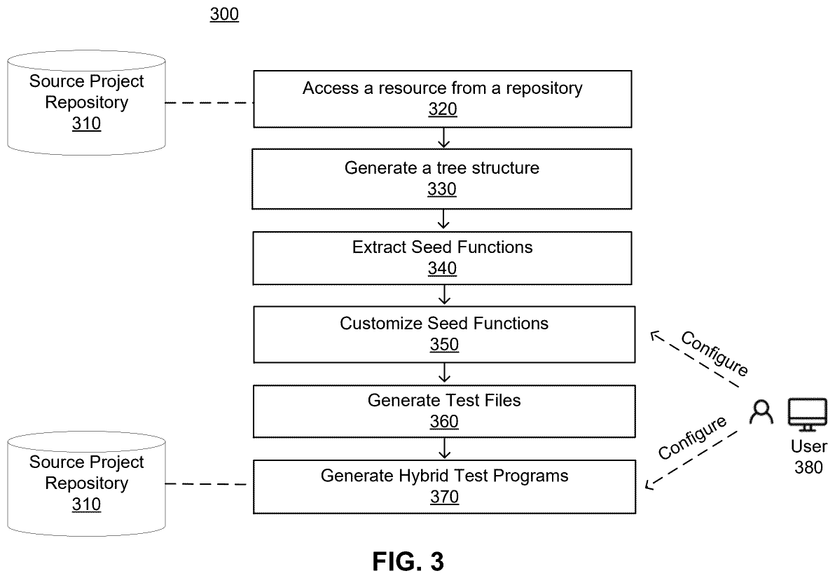

FIG. 3 is a flowchart depicting an example process 300 for generating test cases, in accordance with some embodiments. Various steps in the process 300 may be processes that are performed by the engines of the computing server 130 of FIG. 2, including the access engine 200, the parsing engine 210, the identification engine 220, the vulnerability engine 230, and the aggregation engine 240. Various processes may be implemented as one or more software algorithms. The software algorithm may be stored as computer instructions that are executable by one or more general processors (e.g., CPUs, GPUs). The instructions, when executed by the processors, cause the processors to perform various steps described. In various embodiments, one or more steps described may be skipped or changed. Steps described in FIG. 3 may also be combined with those in other figures. A computer-implemented process may be performed by the computing server 130, although the process may also be performed by another suitable computer.

At 320, the computing server accesses resource from a repository such as the source project repository 310. The resource includes a source code having functions with embedded vulnerability indicators. This access process can include retrieving appropriate source files that match specified criteria, such as programming language requirements and file types containing potential vulnerability indicators.

At 330, the computing server parses the source code to generate a tree structure. This parsing operation transforms the source code into a hierarchical representation that captures the relationships between different code elements, facilitating deeper analysis of the code structure and function definitions. The computing server A parser generator provides fault-tolerant parsing that can process even incomplete or partially incorrect source code without requiring full compilation.

At 340, the computing server extracts seed functions. For example, the computing server identifies one or more functions from the tree structure based on syntactic analysis. This extraction process can include traversing the parsed tree structure to locate distinct function elements based on their syntactic characteristics, determining their depth within the tree, and selecting functions with appropriate complexity levels as indicated by their tree depth.

At 350, the computing server customizes the seed functions based on the user 380 inputs. The computing server can determine, for each identified function, a vulnerability signal based on analysis of the embedded vulnerability indicators. The computing server can apply a rule set using the vulnerability signal to select each identified function for inclusion in an aggregate function file. This customization incorporates user-specified parameters such as target vulnerability density, complexity requirements, and size constraints to tailor the function selection process.

At 360, the computing server generates test files. The computing server may save the test files in the source project repository 310. The computing server can generate the aggregate function file by selectively appending thereto functions selected based on the rule set. This generation process can include retrieving function definitions from the tree structure, combining them into coherent test files, and validating the syntactic correctness of the aggregated code using the parser generator to ensure the test files are structurally sound.

At 370, the computing server generates hybrid test programs. A user 380 may customize the test programs. The computing server may save the test programs in the source project repository 310. These hybrid test programs combine multiple test files into comprehensive test suites that can be used to evaluate security testing tools under various conditions. The hybridization process integrates different vulnerability types and complexity levels to create diverse testing scenarios that challenge the capabilities of security analysis tools.

### Examples of Embodiments

SAST tools are used for identifying vulnerabilities in source code, particularly during the development phase. Existing SAST benchmarks, such as Juliet Test Suite and Defects4J, have notable limitations. Juliet Test Suite contains small programs that are easy for SAST tools to cover completely, offering little challenge for complex vulnerability detection. Defects4J primarily focuses on Java programs and is highly fragmented, limiting its adaptability to multi-language or IDE-based environments. In contrast, the present subject matter is aimed at syntax-directed SAST tools, providing enhanced flexibility in generating customizable, syntax-correct benchmarks that emulate real-world environments. These benchmarks accommodate varying levels of complexity, bug density, and program size.

The present subject matter provides an automated benchmark generation system for SAST tools, capable of dynamically generating syntax-correct test cases through a fault-tolerant syntax analysis engine. One of the features of this system is its ability to extract syntactically correct function seeds from real-world programs without the need for full compilation, enabling the following capabilities: extraction of function seeds from real-world code even if the code is incomplete or partially incorrect; and generation of test cases with customizable complexity, quantity, and bug density, making it possible to evaluate SAST tools under diverse and realistic scenarios. The present subject matter generates hybrid test cases that combine source code and vulnerabilities to assess SAST tools' ability to detect issues in complex source code structures.

The core algorithm of the system leverages fault-tolerant syntax parsing to extract function seeds and generate hybrid test cases, ensuring that the generated code is syntactically correct but not necessarily executable, making it ideal for evaluating SAST tools.

### Syntax-Directed Automated Benchmark Generation Algorithm

The inputs are the following:
openSourceRepoDir: Directory path containing cloned open-source repositories.
baselineTestDir: Directory path containing predefined vulnerability test programs.
config: Custom configuration (syntax tree height, file size, bug density, etc.).

The output is the following: generated hybrid test cases that are syntactically correct and optimized for SAST tool evaluation.

The algorithm steps are as follows.

### A. Pull Open Source Projects

Input: apiURL (the URL of the open-source repository API), openSourceRepoDir (local directory to store repositories)
Output: Cloned open-source repositories in openSourceRepoDir
Function PullOpenSourceRepos(apiURL):
   repos←CallAPI(apiURL)//Fetch a list of popular open-source repositories for each repo in repos do
      if repo not exists in openSourceRepoDir then
         Clone repo into openSourceRepoDir

### B. Extract Seed Functions Using Fault-Tolerant Syntax Parsing

Input: openSourceRepoDir (directory containing the open-source projects), config. maxSeeds (max number of seed functions to extract)
Output: A set of function seed files in SeedDir
Function ExtractSeedFunctions(openSourceRepoDir):
   goFiles←GetAllGoFiles(openSourceRepoDir)//Get all Go files
   seedCount←0
   for each file in goFiles do
      functions←FaultTolerantParseGoFile(file)//Parse even incomplete code
      for each function in functions do
         if seedCount=config.maxSeeds then
         return
         hash←Hash(function)
         Write function to SeedDir using hash as filename
         seedCount←seedCount+1

### C. Customize Seed Functions

Input: SeedDir (directory containing extracted seed files), config.minTreeHeight, config. maxTreeHeight (syntax tree height range)
Output: A filtered set of customized seed files in CustomSeedDir
Function CustomiseSeeds(seedDir):
   seedFiles←GetAllSeedFiles(seedDir)
   for each seedFile in seedFiles do
      tree←ParseSyntaxTree(seedFile)//Parse the function's syntax tree
      treeHeight←CalculateTreeHeight(tree)
      if config. minTreeHeight≤treeHeight≤config.maxTreeHeight then
         Copy seedFile to CustomSeedDir

### D. Generate Test Files

Input: CustomSeedDir (directory containing customized seeds), config.minFileSize, config. numTestFiles (number of test files to generate)
Output: Generated test files in TestFileDir
Function GenerateTestFiles(customSeedDir):
   for i←1 to config.numTestFiles do
      fileSize←0
      while fileSize<config.minFileSize do
         seedFile←RandomPick(customSeedDir)
         Append seedFile to currentTestFile
         fileSize←fileSize+Size(seedFile)
      Save currentTestFile to TestFileDir

### E. Generate Hybrid Test Cases

Input: baselineTestDir (directory containing vulnerability test programs), TestFileDir (directory containing generated test files), config.numHybridTests
Output: Hybrid test programs in HybridTestDir
Function GenerateHybridTests(baselineTestDir, generatedTestDir):
   baselineTests←GetAllTestFiles(baselineTestDir)
   ossTests←GetAllTestFiles(generatedTestDir)
   for i←1 to config.numHybridTests do
      baselineTest ←RandomPick(baselineTests)
      ossTest←RandomPick(ossTests)
      hybridTest←Concatenate(baselineTest, ossTest)//Combine vulnerability tests and OSS tests
      Save hybridTest to HybridTestDir

### Example of Use

Scenario: A developer aims to evaluate a SAST plugin within an IDE using Go programs. The objective is to extract functions from open-source Go repositories, filter them based on complexity, and generate hybrid test programs that integrate open-source functions with vulnerability tests.

Configuration:
Max seeds: 1000
Min/max tree height: 3/10
Min file size: 5000 bytes
Number of test files: 10
Number of hybrid test programs: 5

Step-by-step:

### A. Pull Open Source Projects

The system queries GitHub for popular Go repositories. Five projects are cloned into the local directory.

### B. Extract Seed Functions

The system extracts functions from the Go files, even if some of them are incomplete, using fault-tolerant parsing. The following is an example of a function.
func Add(a int, b int) int {
   return a+b
}

The following function can be saved as a seed file (e.g., f12345.seed)

### C. Customize Seed Functions

The system checks each function's syntax tree height and filters the ones within the 3-10 height range, saving them to the custom seed directory.

### D. Generate Test Files

Randomly selected seeds are combined to form test files of at least 5000 bytes. These files are saved in TestFileDir.

### E. Generate Hybrid Test Programs

Vulnerability test files from the baseline directory are combined with the generated test files to create hybrid test programs, which are saved in HybridTestDir.

Some of the advantages of the present subject matter include:
(1) Fault-tolerant syntax analysis: the ability to extract function seeds from real-world programs without needing to compile the code fully. The fault-tolerant parser can handle incomplete or partially incorrect programs, ensuring the extraction of syntactically correct functions.
(2) Customizable test generation: the system can generate test cases of any complexity, any quantity, and any bug density, allowing full customization based on the user's needs.
(3) Generation of syntactically correct test cases: even though the code may not compile or execute, the generated test cases are always syntactically correct, ensuring they are suitable for testing the detection capabilities of SAST tools.

### Computing System Architecture

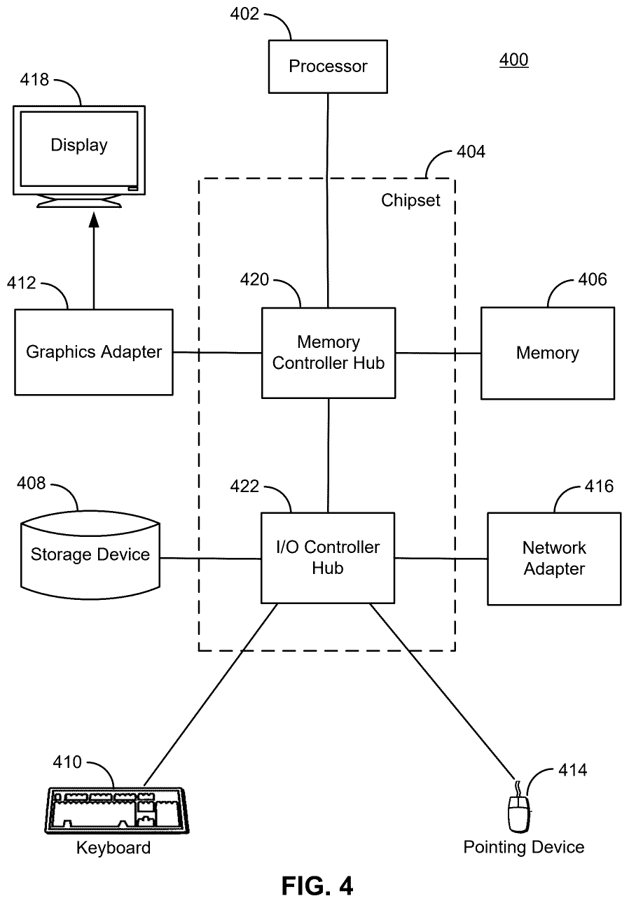

FIG. 4 is a block diagram of an example computer 400 suitable for use as a client device 120 or computing server 130. The example computer 400 includes at least one processor 402 coupled to a chipset 404. The chipset 404 includes a memory controller hub 420 and an input/output (I/O) controller hub 422. A memory 406 and a graphics adapter 412 are coupled to the memory controller hub 420, and a display 418 is coupled to the graphics adapter 412. A storage device 408, keyboard 410, pointing device 414, and network adapter 416 are coupled to the I/O controller hub 422. Other embodiments of the computer 400 have different architectures.

In the embodiment shown in FIG. 4, the storage device 408 is a non-transitory computer-readable storage medium such as a hard drive, compact disk read-only memory (CD-ROM), DVD, or a solid-state memory device. The memory 406 holds instructions and data used by the processor 402. The pointing device 414 is a mouse, track ball, touch-screen, or other type of pointing device, and may be used in combination with the keyboard 410 (which may be an on-screen keyboard) to input data into the computer system 400. The graphics adapter 412 displays images and other information on the display 418. The network adapter 416 couples the computer system 400 to one or more computer networks, such as network 150.

The types of computers used by the entities of FIGS. 1 and 2 can vary depending upon the embodiment and the processing power required by the entity. For example, a system hosting the database 110 might include multiple blade servers working together to provide the functionality described while a client device 120 might be a desktop workstation or tablet. Furthermore, computers 400 can lack some of the components described above, such as keyboards 410, graphics adapters 412, and displays 418.

### Additional Considerations

Some portions of the above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing transactional access to resource repositories. Thus, while particular embodiments and applications have been illustrated and described, it is to be understood that the described subject matter is not limited to the precise construction and components disclosed. The scope of protection should be limited only by any claims that issue.

What is claimed is:

1. A computer-implemented method for generating test cases, comprising:
accessing a resource from a repository, the resource comprising a source code having functions with embedded vulnerability indicators;
parsing, using a parser generator, the source code to generate a tree structure;
identifying one or more functions from the tree structure based on syntactic analysis;
determining, for each identified function, a vulnerability signal based on analysis of the embedded vulnerability indicators;
applying, for each identified function, a rule set using the vulnerability signal to select the each identified function for inclusion in an aggregate function file; and
generating the aggregate function file by selectively appending thereto functions selected based on the rule set.

2. The computer-implemented method of claim 1, wherein accessing the resource from the repository comprises:
identifying a programming language for the test cases; and
selecting the resource from the repository based on file extensions corresponding to the identified programming language.

3. The computer-implemented method of claim 1, wherein the embedded vulnerability indicators comprise data elements within the functions, the data elements indicating potential security vulnerabilities.

4. The computer-implemented method of claim 1, wherein parsing the source code comprises:
using a fault-tolerant parser generator to parse incomplete or partially incorrect source code; and
generating the tree structure without requiring full compilation of the source code.

5. The computer-implemented method of claim 1, wherein parsing the source code comprises:
identifying code components in the tree structure, the code components comprising function definitions, variable definitions, and preprocessor directives.

6. The computer-implemented method of claim 1, wherein identifying the one or more functions from the tree structure comprises:
analyzing components of the tree structure to determine whether a component is a function definition, a variable definition, or a preprocessor directive; and
selecting the components identified as function definitions.

7. The computer-implemented method of claim 6, wherein identifying one or more functions comprises:
determining a depth of each function in the tree structure; and
selecting functions having depths within a predetermined range.

8. The computer-implemented method of claim 1, wherein determining, for each identified function, the vulnerability signal comprises:
parsing data elements associated with each identified function;
identifying the embedded vulnerability indicators within the parsed data elements;
calculating a count of the identified embedded vulnerability indicators within each function;
determining a number of lines of code for each function;
computing a vulnerability density as a ratio of the count of identified embedded vulnerability indicators to the number of lines of code; and
determining the vulnerability signal as a function of the computed vulnerability density.

9. The computer-implemented method of claim 8, wherein determining the vulnerability signal further comprises:
categorizing the identified embedded vulnerability indicators into different vulnerability types;
assigning numerical weights to each vulnerability type based on a severity metric;
calculating a weighted count by applying the numerical weights to the count of identified embedded vulnerability indicators of each vulnerability type;
computing a weighted vulnerability density as a ratio of the weighted count to the number of lines of code; and
determining the vulnerability signal as a function of the weighted vulnerability density.

10. The computer-implemented method of claim 1, wherein applying, for each identified function, the rule set comprises:
comparing the vulnerability signal of each identified function against a predetermined vulnerability threshold.

11. The computer-implemented method of claim 10, further comprising:
receiving the predetermined vulnerability threshold as an input parameter; and
adjusting the predetermined vulnerability threshold based on a target vulnerability density for the aggregate function file.

12. The computer-implemented method of claim 11, wherein generating the aggregate function file comprises:
retrieving function definitions from the tree structure for the functions having vulnerability signals exceeding the predetermined vulnerability threshold; and
combining the retrieved function definitions into the aggregate function file.

13. The computer-implemented method of claim 1, further comprising:
receiving input parameters comprising: a target size for the aggregate function file, a target tree depth, and a target vulnerability density.

14. The computer-implemented method of claim 13, wherein generating the aggregate function file comprises:
selecting functions whose tree structures have depths matching the target tree depth;
continuing to append the selected functions to the aggregate function file until the aggregate function file reaches the target size; and
validating the aggregate function file to include a vulnerability density matching the target vulnerability density.

15. The computer-implemented method of claim 1, further comprising:
validating the aggregate function file using the parser generator to verify syntactic correctness.

16. The computer-implemented method of claim 1, further comprising:
using the aggregate function file to evaluate a performance of a security testing tool.

17. A system, comprising:
a computing server comprising a processor and memory in communication with the processor, the memory configured to store code comprising instructions, wherein the instructions, when executed by the system, cause the system to perform steps comprising:
accessing a resource from a repository, the resource comprising a source code having functions with embedded vulnerability indicators;
parsing, using a parser generator, the source code to generate a tree structure;
identifying one or more functions from the tree structure based on syntactic analysis;
determining, for each identified function, a vulnerability signal based on analysis of the embedded vulnerability indicators;
applying, for each identified function, a rule set using the vulnerability signal to select the each identified function for inclusion in an aggregate function file; and
generating the aggregate function file by selectively appending thereto functions selected based on the rule set.

18. The system of claim 17, wherein accessing the resource from the repository comprises:
identifying a programming language for test cases; and
selecting the resource from the repository based on file extensions corresponding to the identified programming language.

19. The system of claim 17, wherein the embedded vulnerability indicators comprise data elements within the functions, the data elements indicating potential security vulnerabilities.

20. A non-transitory computer readable storage medium storing instructions that, when executed, cause a computing system to perform operations comprising:
accessing a resource from a repository, the resource comprising a source code having functions with embedded vulnerability indicators;
parsing, using a parser generator, the source code to generate a tree structure;
identifying one or more functions from the tree structure based on syntactic analysis;
determining, for each identified function, a vulnerability signal based on analysis of the embedded vulnerability indicators;
applying, for each identified function, a rule set using the vulnerability signal to select the each identified function for inclusion in an aggregate function file; and
generating the aggregate function file by selectively appending thereto functions selected based on the rule set.
